(19) United States
(12) Patent Application Publication
(10) Pub. No.: US 2015/0379797 A1
(43) Pub. Date: Dec. 31, 2015

(54) Medium Recognizing and Counting Apparatus, Financial Device and Financial Management System

(71) Applicant: LG CNS CO., LTD., Seoul (KR)

(72) Inventors: Chang Jin Lee, Seoul (KR); Maeng Cheol Park, Seoul (KR); Hyun Seok Lee, Seoul (KR); Seung Bin Jeon, Seoul (KR)

(21) Appl. No.: 14/753,562

(22) Filed: Jun. 29, 2015

(30) Foreign Application Priority Data
Jun. 30, 2014 (KR) 10-2014-0081099
Jun. 30, 2014 (KR) 10-2014-0081100
Jun. 30, 2014 (KR) 10-2014-0081102
Jun. 11, 2015 (KR) 10-2015-0082394

(51) Int. Cl. G07D 7/20; G06Q 50/34; G07D 11/00; G06Q 20/38

(52) U.S. Cl. CPC G07D 7/20; G06Q 20/381; G06Q 50/34; G07D 11/0024; G07D 11/0033

(57) ABSTRACT

The present disclosure provides a recognizing and counting apparatus having a medium storing function, including: a hopper in which an inserted medium is stacked; a recognizing unit which recognizes an abnormal medium while counting the medium transferred from the hopper; a reject pocket in which abnormal medium recognized to be abnormal by the counting unit is stacked; a normal medium pocket in which a normal medium normally counted by the counting unit is stacked; one or more storage cassette which is disposed below the normal medium pocket to store the normal medium stacked in the normal medium pocket; and a conveying unit which is provided between the counting unit, the normal medium pocket, and the storage cassette to convey the normal medium.

### CROSS-REFERENCE TO RELATED APPLICATIONS

This application claims the benefit 35 U.S.C. §119 of Korean Application Nos. 10-2014-0081099, filed on Jun. 30, 2014; 10-2014-0081100, filed on Jun. 30, 2014; 10-2014-0081102, filed on Jun. 30, 2014; and 10-2015-0082394, filed on Jun. 11, 2015 which are incorporated herein by reference in their entirety.

### BACKGROUND

1. Technical Field

The present disclosure relates to a medium recognizing and counting apparatus, a financial device and a management system.

2. Related Art

Generally, a financial device is a device which automatically processes a financial task which is asked by a user. The financial device may deposit or withdraw a medium (for example, paper money, a check, a security, or a gift certificate) or automatically transfer the medium.

In the meantime, in a company or a financial institution which frequently handles the medium such as paper money, recently a task which recognizes whether a medium is counterfeit is increased due to increase of forgery and a task which classifies various types of medium into individual types is also increased. Therefore, a recognizing and counting apparatus is mainly used to perform a function of checking whether the medium is counterfeit and a type of medium. Even though the recognizing and counting apparatus may very promptly and simply perform a task of checking whether the medium is genuine or forged and a type of medium, the recognizing and counting apparatus does not have a deposit and withdraw function which stores the medium, so that convenience of the user is lowered.

The financial device is generally manlessly operated and is manipulated by a client to process the financial task. However, a deposit and withdrawal machine for a cashier in which a cashier is positioned at a counter to deposit the money of the client by the cashier and automatically calculate the money is frequently utilized.

The deposit and withdrawal machine for a cashier of the related art has an advantage of performing various functions of counting or storing the medium, but usability thereof is lower than the recognizing and counting apparatus. The deposit and withdrawal machine for a cashier has a relatively big size, but applicability thereof is extremely low and specifically, is never used in fields (for example, a casino or a retail shop) other than the bank due to the big size.

In the meantime, the casino is being changed into a place of amusement or a gambling place having various amusement facilities and a complex vacation spot in which sightseeing and various amusements are combined. A negative image of a casino industry is changed into a positive image because the casino industry obtains foreign currency, helps increase tourism income, regional development, and vitalize regional economic.

The casino is configured by a game table on which players participate in a game such as Baccarat or roulette using chips, an exchange counter which exchanges chips or money, and an adjustment counter which calculates the money received through the game table or the exchange counter and a dealer which controls the game is positioned in the game table and cashiers are positioned at the exchange counter and the adjustment counter to handle an exchange task and a calculating task.

Generally, the players exchange the cash or the checks for chips at the exchange counter in the casino. However, change (for example, coins) may be obtained during a process of exchanging the cash or the checks for the chips, and it may be inconvenient for the players to carry the change. Further, generally, the cash is handled by employees of the casino, such as the dealer or the cashier in the casino so that it is difficult to establish transparent cash management.

### BRIEF SUMMARY

The present disclosure has been made in an effort to provide a recognizing and counting apparatus having a medium storing function which implements a deposit function such as storage and recognition of a medium which is normally counted, in addition to a recognizing and counting function such as a function of checking whether the medium is counterfeit or the type of medium and significantly reduces a size as compared with a deposit and withdrawal machine for a cashier of the related art so as to be effectively used not only in a financial institution but also in a casino or a retail shop.

The present disclosure has been made in an effort to minimize inconvenience of a player to carry coins generated at the time of exchanging the chips.

The present disclosure has also been made in an effort to provide a financial device for calculating in a casino, a financial device for exchanging in a casino, and a casino management system which may improve transparency of cash management.

Technical objects of the present disclosure are not limited to the aforementioned technical objects and other technical objects which are not mentioned will be apparently appreciated by those skilled in the art from the following description.

An exemplary embodiment of the present disclosure provides a financial device, including: an input unit which receives an ID of a dealer who is in charge of a first cassette or a second cassette; an adjusting unit which collects a first medium stored in the first cassette and a second medium stored in the second cassette to at least one adjusting cassette; a communication unit which communicates with the server; a control unit which transmits an adjusting result for the first medium or the second medium collected by the adjusting unit to the server; and a display unit which outputs the adjusting result.

An exemplary embodiment of the present disclosure provides a financial device, including: a medium accepting/dispensing unit which counts, recognizes, and stores a medium inserted by a user, a communication unit which communicates with a server; and a control unit which calculates and outputs information on the number of chips which are exchangeable from the medium, transmits the chip exchanging result to the server, and when a change is generated during the chip exchanging process, transmits a result of accumulating the change corresponding to a membership number of a user based on whether the user has a membership of the casino or a result of issuing a ticket for the change to the server.

An exemplary embodiment of the present disclosure provides a financial management system, including: a server; a first financial device which stores an inserted first medium, calculates information of the number of chips which is exchanged by the first medium, and transmits a chip exchanging result of the first medium to the server; a second financial device which stores an inserted second medium, obtains exchange rate information of the second medium, exchanges the second medium using the exchange rate information to transmit the exchanging result to the server; and a third financial device which collects the first medium or the second medium to perform adjustment process and transmits the adjustment result to the server.

An exemplary embodiment of the present disclosure provides a recognizing and counting apparatus, including: a counting unit including a hopper in which an inserted medium is stacked; a first separating unit which separates the medium stacked in the hopper into a sheet of the medium and transfers the medium; a recognizing unit which recognizes the medium transferred from the hopper; a reject pocket in which an abnormal medium recognized to be abnormal by the recognizing unit is stacked; a normal medium pocket in which a normal medium normally counted by the recognizing unit is stacked; and a second separating unit which separates medium stacked in the normal medium pocket into a sheet of the medium to transfer the medium; one or more storage cassette which is disposed below the normal medium pocket to store the normal medium stacked in the normal medium pocket; and a conveying unit which is provided between the counting unit, the normal medium pocket, and the storage cassette to convey the normal medium which is separated into a sheet of the medium by the second separating unit.

### BRIEF DESCRIPTION OF THE DRAWINGS

FIG. 1 illustrates a casino management system according to an exemplary embodiment of the present disclosure.

FIG. 2 more specifically illustrates a casino management system according to an exemplary embodiment of the present disclosure.

FIG. 3 is a block diagram illustrating a first financial device of a casino management system according to an exemplary embodiment of the present disclosure.

FIG. 4 is a flow chart illustrating an operation according to a first exemplary embodiment of the first financial device according to the exemplary embodiment of the present disclosure.

FIG. 5 is a flow chart illustrating an operation according to a second exemplary embodiment of the first financial device according to the exemplary embodiment of the present disclosure.

FIG. 6 is a block diagram illustrating a second financial device of a casino management system according to an exemplary embodiment of the present disclosure.

FIG. 7 is a flow chart illustrating an operation of a second financial device according to an exemplary embodiment of the present disclosure.

FIG. 8 is a block diagram illustrating a third financial device of a casino management system according to an exemplary embodiment of the present disclosure.

FIG. 9 is a flow chart illustrating an operation according to a first exemplary embodiment of the third financial device of the casino management system according to the exemplary embodiment of the present disclosure.

FIG. 10 is a flow chart illustrating an operation according to a second exemplary embodiment of the third financial device of the casino management system according to the exemplary embodiment of the present disclosure.

FIG. 11 is a view illustrating a recognizing and counting apparatus having a medium storing function according to a first exemplary embodiment of the present disclosure and illustrates a medium recognizing and counting process.

FIG. 12 is a view illustrating a storing process of a recognizing and counting apparatus having a medium storing function according to a first exemplary embodiment of the present disclosure.

FIG. 13 is a view illustrating a recognizing and counting apparatus having a medium storing function according to a second exemplary embodiment of the present disclosure.

FIG. 14 is a view illustrating a withdrawal process of a recognizing and counting apparatus having a medium storing function according to a second exemplary embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, some exemplary embodiments of the present disclosure will be described in detail with reference to the accompanying drawings. In the figures, even though the parts are illustrated in different drawings, it should be understood that like reference numerals refer to the same parts of the present disclosure. In describing the embodiments of the present disclosure, when it is determined that the detailed description of the known configuration or function related to the present disclosure may obscure the understanding of embodiments of the present disclosure, the detailed description thereof will be omitted.

In describing components of the exemplary embodiment of the present disclosure, terminologies such as first, second, A, B, (a), (b), and the like may be used. However, such terminologies are used only to distinguish a component from another component but nature or an order of the component is not limited by the terminologies. If it is described that a component is “connected” or “coupled” to another component, it is understood that the component is directly connected or coupled to the other component but another component may be “connected” or “coupled” between the components.

For example, financial devices of a casino management system according to an exemplary embodiment of the present disclosure are apparatuses which perform a financial task to of receiving various medium such as paper money, checks, securities, giro, coins, or gift certificates to perform medium processing including as a processing such as deposit processing, giro payment, exchange of the gift certificate and/or withdrawal processing, giro dispensing, or gift certificate dispensing. Examples of the financial devices may be an automatic teller's machine (ATM) such as a cash dispenser (CD) or a cash recycling device. However, the financial device is not limited to the above-mentioned example, but may be a device which automates a financial task like a financial information system (FIS).

Hereinafter, an exemplary embodiment of the present disclosure will be described under the assumption that the financial device is a teller cash recycler (TCR). However, the assumption is made only for convenience of description, but the technical spirit of the present disclosure is not limited to the TCR. Further, in the following description, the “medium” may refer to paper money and checks as currency (that is, won or foreign currency) of each country, but the medium is not limited thereto and may include various types of securities or gift certificates. Further, hereinafter, a first financial device 100, a second financial device 200, and a third financial device 300 may be described with respect to main functions, but the function of each financial device is not interpreted to be limited thereto and the first financial device 100 and the second financial device 200, and the third financial device 300 may be interpreted to have functions of other financial devices. For example, the first financial device 100 may include all of the functions of the second financial device 200 and the third financial device 300.

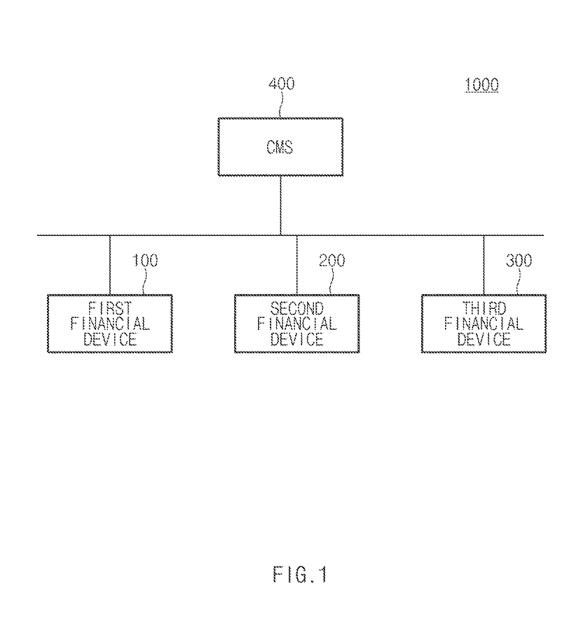

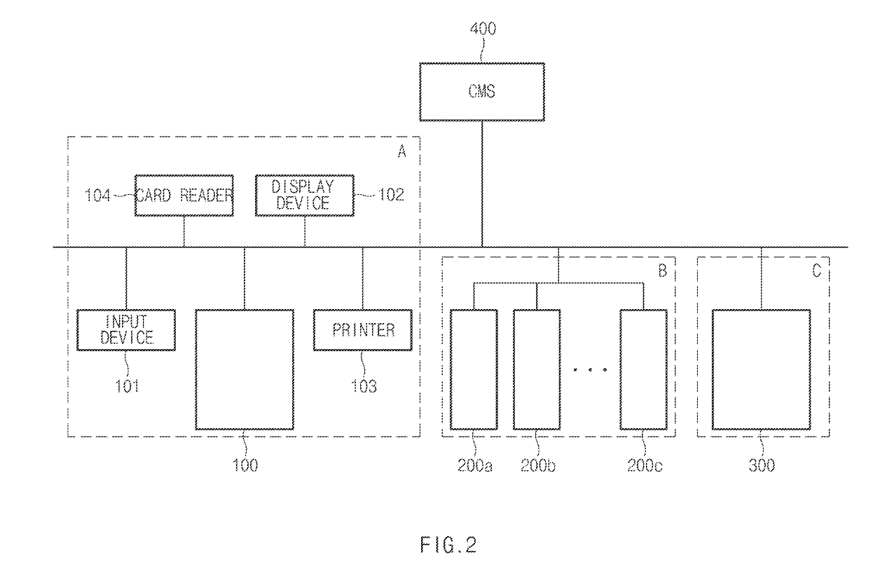

FIG. 1 illustrates a casino management system according to an exemplary embodiment of the present disclosure. FIG. 2 more specifically illustrates a casino management system according to an exemplary embodiment of the present disclosure.

Referring to FIGS. 1 and 2, a casino management system 1000 may include a first financial device 100, a second financial device 200, a third financial device 300, and a casino management server (CMS) 400.

The first financial device 100, the second financial device 200, the third financial device 300, and the CMS 400 may communicate with each other through a local area network (LAN), but are not limited thereto, and may communicate with each other through various wired or wireless communication networks.

The first financial device 100 may be placed in a game table area A. The game table area A may be divided into an area where a player is located and an area where a dealer is located. In addition to the first financial device 100, an input device 101, a display device 102, a printer 103, and a card reader 104 may be additionally connected to the game table area A through a LAN.

The first financial device 100 may be placed in an area where the dealer is located to output information on the number of chips which may be exchanged for a medium (for example, won or foreign currency) which is received from the player. Chips may be configured by various types having different momentary values and the information on the number of chips output from the first financial device 100 may include the type of chip and the number of chips.

Specifically, when a player asks to exchange a predetermined medium for chips, a dealer presses a start button of the input device 101 and inserts the received medium into the first financial device 100. When the inserted medium is Korean won, the first financial device 100 calculates information on the number of chips which are exchanged from the inserted medium to output the information through the display device 102. When the inserted medium is a foreign currency, the first financial device 100 checks information on an exchange rate corresponding to the inserted medium through the CMS 400 and calculates the inserted medium by Korean won to output information on the number of exchangeable chips through the display device 102. Therefore, the dealer checks information on the number output from the first financial device 100 and provides chips corresponding to the information on the number to players. Further, the first financial device 100 may transmit a chip exchanging result to the CMS 400. Accordingly, the CMS 400 may figure out a medium which is received through the first financial device 100 in real time.

When change is given during the process of creating the information on the number of chips which are exchanged from the inserted medium (for example, when there are coins in change medium in accordance with the exchange rate during the process of exchanging one dollar for 1000 won chips), the first financial device 100 outputs a ticket for the change andior a receipt for the change through the printer 103. The player may receive the change at an exchange counter area B or an adjustment counter area C using the output ticket for the change and/or the output receipt for the change. Moreover, when the player is a member having a membership of the casino, the first financial device 100 communicates with the CMS 400 to save the generated change in a membership card.

The second financial device 200 may be placed in the exchange counter area B. The exchange counter area B may be defined as an area where the chip is exchanged for a medium and/or an area where a medium is exchanged for another medium. In the exchange counter area B, a plurality of second financial devices 200a, 200b, . . . , 200c and each of the second financial devices 200a, 200b, . . . , 200c may be connected to the CMS 400 through the local area network (LAN).

When a user wants to exchange the chip for a medium, the user gives the chips to a cashier located at the exchange counter area B and the cashier counts the received chips to input an amount corresponding to the chip to the second financial device 200. The second financial device 200 counts and withdraws the input amount and transmits the processing result to the CMS 400.

When the user wants to exchange a medium for another medium (for example, exchange Korean won for a foreign currency or exchange a foreign currency for Korean won), the user may select the second financial device 200a, 200b, . . . , 200c which exchanges a desired medium. That is, the second financial devices 200a, 200b, . . . , 200c may exchange between medium in accordance with the selection of the user, that is, exchange Korean won for a foreign currency or exchange a foreign currency for Korean won. Further, the second financial devices 200a, 200b, . . . , 200c may exchange medium from different countries. For example, the second financial device 200a exchanges US dollar (USD), the second financial device 200b exchanges Chinese yuan, and the second financial device 200c exchanges Japanese yen. The second financial device 200a, 200b, . . . , 200c transmits an exchanging result to the CMS 400.

The third financial device 300 may be placed in the adjustment counter area C. The adjustment counter area C may be defined as an area where the medium received through the first financial device 100 and/or the second financial device 200a, 200b, . . . , 200c is adjusted at a predetermined time. The third financial device 300 is mounted with a medium storing cassette collected from the first financial device 100 and/or the second financial devices 200a, 200b, . . . , 200c to count and adjust the medium stored in the first financial device 100 and/or the second financial devices 200a, 200b, . . . , 200c. The third financial device 300 transmits the adjusting result to the CMS 400. Therefore, the medium is not directly calculated, adjusted, and transferred by a cashier or other casino employee during the adjusting process, so that transparent cash management may be established.

The CMS 400 which receives the adjusting result compares an adjusting result for the first financial device 100 with the chip exchanging result which is transmitted from the first financial device 100 and compares an adjusting result for the second financial devices 200a, 200b, . . . , 200c with the exchanging result received from the second financial devices 200a, 200b, . . . , 200c to determine whether the results match each other.

The CMS 400 may receive the chip exchanging result, the exchanging result, and the adjusting result from the first financial device 100, the second financial devices 200a, 200b, . . . , 200c, and the third financial device 300 through the local area network (LAN). Therefore, a casino manager may manage a medium accepting/dispensing situation, and a flow of the medium in the casino through the CMS 400 in real time, so as to efficiently perform the cash management.

Hereinafter, configurations and operations of the first financial device 100, the second financial device 200, and the third financial device 300 will be described in more detail.

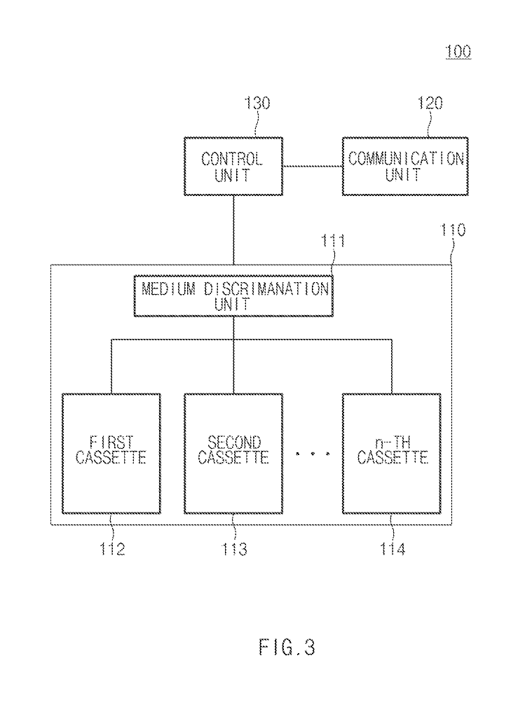

FIG. 3 is a block diagram illustrating a first financial device of a casino management system according to an exemplary embodiment of the present disclosure.

Referring to FIGS. 2 and 3, the first financial device 100 according to an exemplary embodiment of the present disclosure may include a medium accepting/dispensing unit 110, a communication unit 120, and a control unit 130. Further, the first financial device 100 may further include a display unit 140 and an input unit 150.

The medium accepting and dispensing unit 110 may include a medium discrimination unit 111 which recognizes whether an inserted medium is counterfeit and counts the medium and at least one of the cassettes 112, 113, . . . , 114 which store the medium.

When the inserted medium is counterfeit, the medium discrimination unit 111 may eject the inserted medium. When the inserted medium is a check, the medium discrimination unit 111 may read information of the check to determine whether the check is issued from an inward bank or an outward bank. Here, the check information may include a special image and magnetic ink character recognition (MICR) information. The check which is issued from this bank is defined as a check which is issued from a predetermined bank and the check which is issued from the outward bank is defined as a check which is issued from a bank other than the predetermined bank. Generally, a bank which is open in the casino issues a check by printing a special image on the check which is issued from a branch of the bank so that the check issued from the open branch is distinguished through the special image. Further, when the inserted check is issued from the inward bank, the medium discrimination unit 111 may determine whether the inserted check is issued from a bank branch which is open in the casino using the read check information.

At least one cassette 112, 113, . . . , 114 may store medium (for example, paper money and check) from different countries. For example, the cassette 112 stores Korean won paper money, the cassette 113 stores US dollars (USD), and the cassette 114 stores Korean won checks.

The communication unit 120 may communicate with the input device 101, the display device 102, the printer 103, a card reader 104, and the CMS 400 through a local area network (LAN). For example, the communication unit 120 receives a processing start signal through the input device 101 and transmits a counting result of inserted medium to the display device 102. Further, the communication unit 120 transmits information of the ticket for change and/or a receipt for change with respect to the change generated during the chip exchanging process to the printer 103. Further, the communication unit 120 receives exchange rate information corresponding to the medium which is inserted through the medium accepting/dispensing unit 110 from the CMS 400. The communication unit 120 transmits a chip exchanging result for the inserted medium to the CMS 400. For example, the chip exchanging result may include an amount of received medium and information on a type and the number of exchanged chips.

When the control unit 130 receives the processing start signal through the communication unit 120, the control unit 130 opens the medium accepting/dispensing unit 110 to insert the medium. The control unit 130 receives the counting result of the inserted medium from the medium discrimination unit 111 and outputs the counting result through the display device 102 and/or the display unit 140.

The control unit 130 outputs information on the number of chips which may be exchanged for the inserted medium through the display device 102 and/or the display unit 140. For example, when the inserted medium is Korean won, the control unit 130 calculates information on the number of chips which may be exchanged for the inserted medium and outputs the information through the display device 102 and/or the display unit 140. When the inserted medium is a foreign currency, the control unit 130 receives exchange rate information corresponding to the inserted medium from the CMS 400 through the communication unit 120, calculates the inserted medium by Korean won using the exchange rate information, and calculates the information on the number of chips which are exchangeable from the calculated amount of Korean won to output the information through the display device 102 and/or the display unit 140. The control unit 130 transmits the chip exchanging result for the inserted medium (for example, paper money or check) to the CMS 400.

The control unit 130 processes the inserted medium in accordance with a recognized result of whether the check is issued by the inward bank or the outward bank when the inserted medium is a check and a recognized result of whether the check is issued by a branch open in the casino when the check is issued by this bank. Specifically, when the inserted check is issued by the outward bank or when the check is issued by this bank but is issued by a branch other than the branch open in the casino, the control unit 130 transmits check information to the CMS 400. The control unit 130 finally determines whether the inserted check can be transacted by receiving a check inquiring result from the CMS 400. When the inserted check is issued by this bank and also issued by the branch in the casino or when the inserted check can be transacted in accordance with the check inquiring result received from the CMS 400, the control unit 130 outputs the information on the number of chips which are exchangeable from the inserted check to the display device 102 and/or the display unit 140.

When the change is given during the process of generating the information on the number of chips which is exchangeable from the inserted medium, the control unit 130 checks whether a player who asks to exchange the chip has a membership of the casino. Specifically, when the change is generated, the control unit 130 outputs a message of requesting a membership card in the case of the member and a message of requesting to input a password in the case of a non-member, through the display device 102 and/or the display unit 140. When the membership card is read through a card reader 104, the control unit 130 may accumulate the generated change in the membership card. When the password is input through the input device 101 and/or the input unit 150, the control unit 130 may issue the ticket for the change and/or the receipt for the change through the printer 103. The ticket for the change may include an amount of the change and a serial number.

The control unit 130 transmits an accumulating result and a result of issuing the ticket for the change to the CMS 400. Further, when the user who asks to exchange the chip possesses the issued ticket for the change, the control unit 130 checks the amount of the change of the ticket for the check which has been already issued to the CMS 400 using the serial number of the issued ticket for change which is input through the input device 101 and/or the input unit 150. The control unit 140 adds the amount of the change of the issued ticket for the change and the change which is additionally issued by issuing a new ticket for the change.

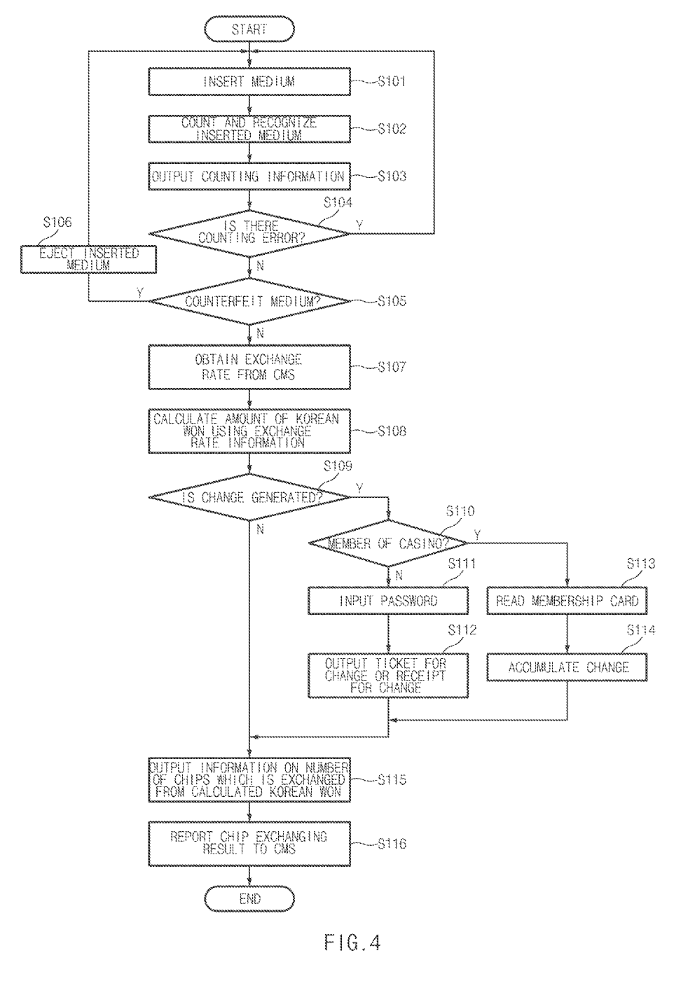

FIG. 4 is a flow chart illustrating an operation according to a first exemplary embodiment of the first financial device according to the exemplary embodiment of the present disclosure. Specifically, a case in which a foreign medium is injected to the first financial device 100 will be described with reference to FIG. 4. That is, FIG. 4 illustrates an exemplary embodiment in which a player asks to exchange the foreign currency for chips.

Referring to FIG. 4, an operating method according to a first exemplary embodiment of a first financial device according to an exemplary embodiment of the present disclosure may include a step S101 of inserting medium, a step S102 of counting and recognizing the inserted medium, a step S103 of outputting counting information, a step S104 of determining whether there is a counting error, a step S105 of determining whether the inserted medium is counterfeit medium, a step S106 of ejecting the inserted medium when the inserted medium is counterfeit medium, a step S107 of obtaining information on an exchange rate corresponding to the inserted medium from the CMS, a step S108 of calculating Korean won corresponding to an amount of the inserted medium using the exchange rate information, a step S109 of determining whether there is change, a step S115 of outputting information of the number of chips which are exchangeable for the calculated won when there is no change, and a step S116 of transmitting a chip exchanging result to the CMS.

When it is determined that there is change as a determining result of step S109, the method may further include a step S110 of determining whether the player who asks to exchange the chips is a member of the membership of the casino, a step S111 of inputting a password when the player is not the member the membership, a step S112 of outputting a ticket for change and/or a receipt for change, a step S113 of reading a membership card when the player is the member of the membership, and a step S114 of accumulating the generated change in the membership card.

Hereinafter, steps S101 to S116 will be described in more detail with reference to FIGS. 2 and 3.

First, in step S101, the control unit 130 may open the medium accepting/dispensing unit 110 in response to a processing start signal which is transmitted from the input device 101. When the medium accepting/dispensing unit 110 is open, the medium which is received from the player is inserted into the medium accepting/dispensing unit 110 by the dealer.

In step S102, the medium discrimination unit 111 of the medium accepting/dispensing unit 110 counts and recognizes the inserted medium.

In step S103, the control unit 130 outputs counting information of the inserted medium through the display device 102.

In step S104, whether there is no error in the counting information, the control unit 130 receives a progressing command from the input device 101 and when there is an error in the counting information, the control unit 130 receives a recounting command from the input device 101. When the recounting command is received from the input device 101, the control unit 130 controls the medium accepting/dispensing unit 110 to recount reinserted medium.

In step S105, the medium discrimination unit 111 of the medium accepting/dispensing unit 110 determines whether the inserted medium is a counterfeit medium using information which is read from the inserted medium.

In step S106, the medium discrimination unit 111 of the medium accepting/dispensing unit 110 ejects the inserted medium when the inserted medium is a counterfeit medium.

In step S107, when the inserted medium is not a counterfeit medium, the control unit 130 obtains exchange rate information corresponding to the inserted medium from the CMS 400.

In step S108, the control unit 130 calculates the amount of won corresponding to the inserted medium using the exchange rate information which is received from the CMS 400 and calculates information on the number of chips which may be exchanged from the calculated won.

In step S109, the control unit 130 may determine whether there is change during the process of calculating the information on the number of chips which may be exchanged from the inserted medium. For example, when inserted one dollar is exchanged for 1000 won chip, coin change may be generated depending on the exchange rate.

In step S110, when the change is generated, the control unit 130 outputs a message of requesting a membership card in the case of the member and a message of requesting to input a password in the case of a non-member, through the display device 102 and/or the display unit 140.

In step S111, when the player who asks to exchange the chip doesn't have a membership of the casino, the password is input through the input device 101 and/or the input unit 150.

In step S112, the control unit 130 reports information on the input password and the change to the CMS 400 through the communication unit 120 and outputs the ticket for the change and/or the receipt for the change through the printer 103. The ticket for the change may include an amount of the change and a serial number. The user may input the password and/or the serial number to receive the change in the exchange counter area B or the adjustment counter area C using the output ticket for the change and/or the output receipt for the change.

In step S113, when the player who asks to exchange the chip is a member of the membership, the membership card may be read through the card reader 104.

In step S114, the control unit 130 accumulates the change in the read membership card and transmits the accumulating result to the CMS 400.

In step S115, the control unit 130 outputs information of the number of chips which may be exchanged by the amount of won calculated from the inserted medium through the display device 102 and/or the display unit 140.

In step S116, the control unit 130 transmits the chip exchanging result to the CMS 400 through the communication unit 120. For example, the chip exchanging result may include an amount of received medium and information on a type and the number of exchanged chips. Therefore, the medium which is received by the first financial device 100 to be exchanged for the chip may be managed through the CMS 400 in real time.

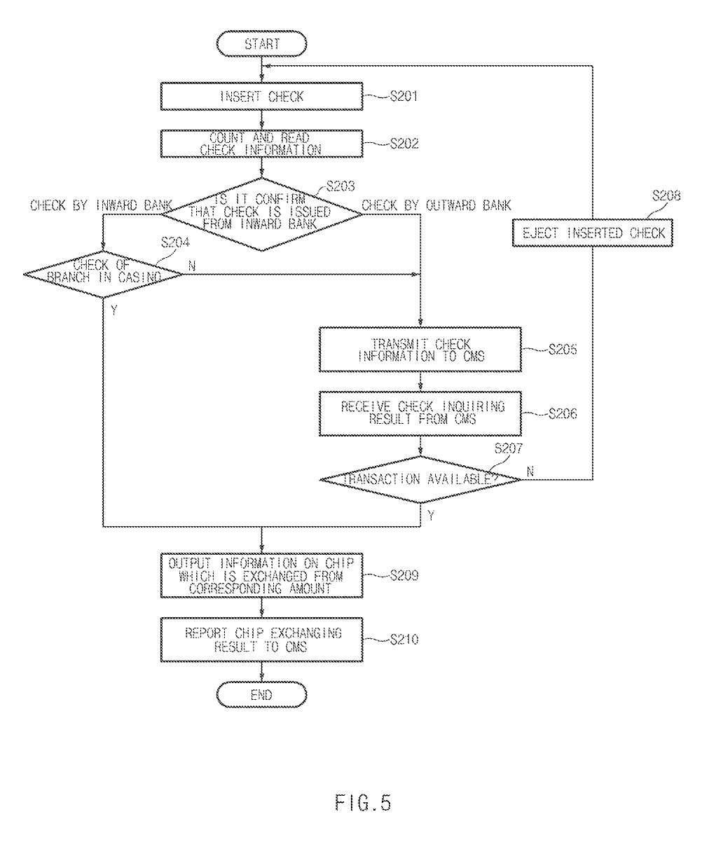

FIG. 5 is a flow chart illustrating an operation according to a second exemplary embodiment of the first financial device according to the exemplary embodiment of the present disclosure. In FIG. 5, a case in which a check is inserted into the first financial device will be described. That is, FIG. 5 illustrates an exemplary embodiment in which a player asks to exchange the check for chips.

Referring to FIG. 5, an operating method according to a second exemplary embodiment of a first financial device according to an exemplary embodiment of the present disclosure may include a step S201 of inserting a check, a step S202 of counting the inserted checks and reading check information, a step S203 of determining whether the inserted check is issued by this bank, a step S204 of determining whether the inserted check is issued from a branch in the casino when the inserted check is issued by this bank, a step S205 of transmitting the check information to the CMS when the inserted check is issued by another bank or when the inserted check is issued by this bank but is not issued from the branch in the casino, a step S206 of receiving an inquiry result for the inserted check from the CMS, a step S207 of determining whether the inserted check can be transacted based on the received inquiring result, a step S208 of ejecting the inserted check when the inserted check cannot be transacted, a step S209 of outputting information on the number of chips which are exchanged from the inserted check when the inserted check can be transacted or is issued from the branch in the casino, and a step S210 of transmitting a chip exchanging result to the CMS.

Hereinafter, steps S201 to S210 will be described in more detail with reference to FIGS. 2 and 3.

First, in step S201, the control unit 130 opens the medium accepting/dispensing unit 110 in response to a processing start signal which is transmitted from the input device 101. When the medium accepting/dispensing unit 110 is open, the check which is received from the player is inserted into the medium accepting/dispensing unit 110 by the dealer.

In step S202, the medium discrimination unit III of the medium accepting/dispensing unit 110 counts the inserted checks and reads out the check information from the inserted check.

In step S203, when the inserted medium is a check, the medium discrimination unit III may read information of the check to determine whether the check is issued from the inward bank or the outward bank. Here, the check information may include a special image and magnetic ink character recognition (MICR) information.

In step S204, when the inserted check is issued from this bank, the medium discrimination unit 111 determines whether the inserted check is issued from a bank branch which is open in the casino using the read check information.

In step S205, when the inserted check is issued by the outward bank or the check is issued by this bank but is issued by a branch other than the branch in the casino, the control unit 130 transmits check information to the CMS 400.

In step S206, the control unit 130 receives the check inquiring result from the CMS 400. For example, the CMS 400 communicates with a bank server (not illustrated) to inquire whether the inserted check can be transacted.

In step S207, the control unit 130 determines whether the inserted check can be transacted based on the received check inquiring result.

In step S208, when the inserted check cannot be transacted, the control unit 130 controls the medium accepting/dispensing unit 110 to eject the inserted check.

In step S209, when the inserted check is issued by this bank and also issued by the branch in the casino or when the inserted check can be transacted in accordance with the check inquiring result received from the CMS 400, the control unit 130 outputs the information on the number of chips which is exchangeable from the inserted check to the display device 102.

In step S210, the control unit 130 transmits the chip exchanging result to the CMS 400 through the communication unit 120.

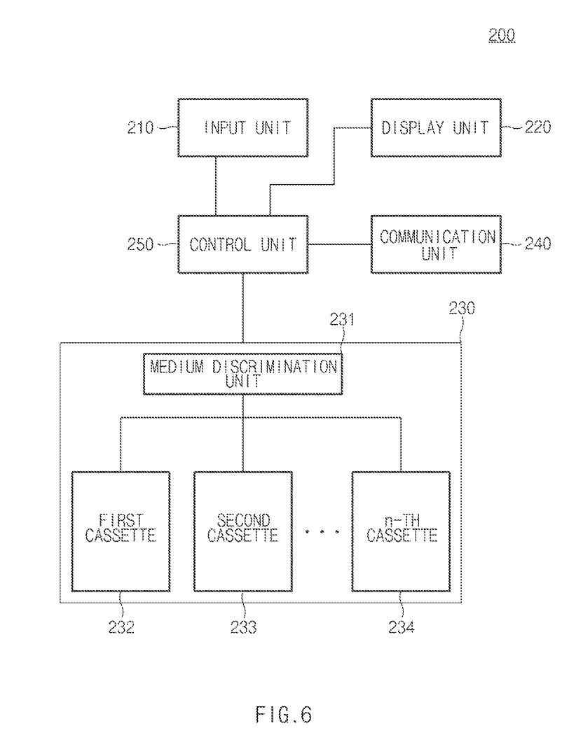

FIG. 6 is a block diagram illustrating a second financial device of a casino management system according to an exemplary embodiment of the present disclosure.

Referring to FIG. 6, the second financial device 200 of the casino management system according to an exemplary embodiment of the present disclosure may include an input unit 210, a display unit 220, a medium accepting/dispensing unit 230, a communication unit 240, and a control unit 250.

The input unit 210 receives various commands to perform a transaction processing from the user. For example, the input unit 210 receives a transaction processing to exchange won for a foreign currency or a transaction processing command to exchange a foreign currency for won from the user.

The display unit 220 outputs various information generated during the transaction processing process. For example, the display unit 220 outputs counting information for the inserted medium, exchanging information (for example, which foreign currency is handled), exchange rate information (for example, what is the current exchange rate?), and/or processing result information. Further, the display unit 220 and the input unit 210 may be configured by one module, like a touch panel or a touch screen and the user may check the information output from the display unit 220 and input a command corresponding to the output information by touch.

The medium accepting/dispensing unit 230 may include a medium discrimination unit 231 which recognizes whether an inserted medium is counterfeit and counts the medium and at least one of the cassettes 231, 232, . . . , 233 which store the medium. When the inserted medium is counterfeit, the medium discrimination unit 231 may eject the inserted medium. At least one cassette 232, 233, . . . , 234 may store different types of medium, respectively. For example, when the second financial device 200 is an apparatus of exchanging won and US dollars, the cassette 232, the cassette 233, and the cassette 234 may store a 10,000 won paper money, a 50,000 won paper money, and US dollar but are not limited thereto.

The communication unit 240 communicates with the CMS 400 through the local area network (LAN). For example, the communication unit 240 receives exchange rate information corresponding to the medium which is inserted through the medium accepting/dispensing unit 230 from the CMS 400. The communication unit 240 transmits a chip exchanging result for the inserted medium to the CMS 400. For example, the exchanging result may include an amount of received medium, a type of exchanged medium; and amount information.

The control unit 250 requests the exchange information corresponding to the inserted medium to the CMS 400 and exchanges the inserted medium using the received exchange rate information. Specifically, the control unit 250 exchanges the medium in accordance with information of selecting the number of sheets for every type input through the input unit 210 and discharges the exchanged amount through the medium accepting/dispensing unit 230. Further, the control unit 250 transmits an exchanging result to the CMS 400 through the communication unit 240. Further, the control unit 250 controls overall operations of the input unit 210, the display unit 220, the medium accepting/dispensing unit 230, and the communication unit 240.

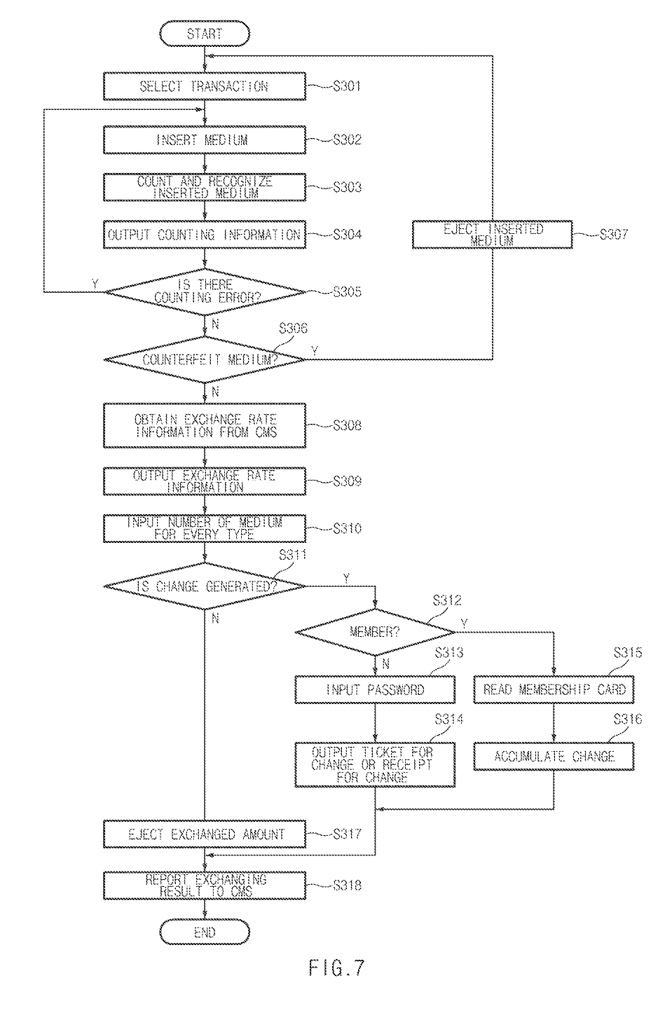

FIG. 7 is a flow chart illustrating an operation of a second financial device according to an exemplary embodiment of the present disclosure. In FIG. 7, for the convenience of description, the second financial device 200 exchanges the won and the USD.

Referring to FIG. 7, an operating method of a second financial device 200 according to an exemplary embodiment of the present disclosure may include a step S301 of selecting, by a user, transaction, a step S302 of inserting medium, a step S303 of counting and recognizing the inserted medium, a step S304 of outputting counting information, a step S305 of determining whether there is a counting error, a step S306 of determining whether the inserted medium is counterfeit medium, a step S307 of ejecting the inserted medium when the inserted medium is counterfeit medium, a step S308 of obtaining exchange rate information corresponding to the inserted medium from the CMS, a step S309 of outputting the exchange information, a step S310 of inputting information of selecting the number of sheets for every type from the user, a step S311 of determining whether there is change, a step S317 of ejecting the exchanged medium when there is no change, and a step S318 of transmitting an exchanging result to the CMS.

When there is change as a determining result of step S311, the method may further include a step S312 of determining whether the user is a member of the membership of the casino, a step S313 of receiving a password when the user is not the member of the membership, a step S314 of outputting the ticket for the change and/or the receipt for the change, a step S315 of receiving a membership number when the user is a member of the membership, and a step S316 of requesting the CMS to accumulate the generated change in the membership number.

Hereinafter, steps S301 to S318 will be described in more detail with reference to FIG. 6.

First, in step S301, the input unit 210 receives a transaction processing to exchange won for US dollars (USD) or a transaction processing command to exchange US dollars for won from the user. Hereinafter, it is assumed that the transaction processing command to exchange the US dollar (USD) for won is input.

In step S302, the control unit 250 may open the medium accepting/dispensing unit 110 in response to the transaction processing command which is transmitted from the input unit 210. When the medium accepting/dispensing unit 230 is open, medium may be inserted into the medium accepting/dispensing unit 230 from the user.

In step S303, the medium determining unit 231 of the medium accepting/dispensing unit 230 may count and recognize the inserted medium.

In step S304, the control unit 250 outputs counting information of the inserted medium through the display unit 220.

In step S305, whether there is no error in the counting information, the control unit 250 receives a progressing command from the input unit 210 and whether there is an error in the counting information, the control unit 130 receives a recounting command from the input unit 210. When the recounting command is received from the input unit 210, the control unit 250 controls the medium accepting/dispensing unit 230 to recount reinserted medium.

In step S306, the medium determining unit 231 of the medium accepting/dispensing unit 231 may determine whether the inserted medium is a counterfeit medium using information which is read from the inserted medium.

In step S307, the medium determining unit 231 of the medium accepting/dispensing unit 230 ejects the inserted medium when the inserted medium is a counterfeit medium.

In step S308, when the inserted medium is not a counterfeit medium, the control unit 250 obtains exchange rate information corresponding to the inserted medium from the CMS 400.

In step S309, the control unit 250 calculates an amount of won corresponding to the inserted medium using the exchange rate information which is received from the CMS 400 and outputs exchange information using an amount of the inserted medium and the amount of won calculated on the display unit 220. That is, the exchange information may include an amount corresponding to the inserted paper money and information on an amount which is calculated as the won.

In step S310, the input unit 210 receives the information by selecting the number of sheets for every type from the user. For example, the information for selecting the number of sheets for every type may refer to the number of sheets for every type (for example, a 10,000 won paper money, a 50,000 won paper money, and check) which will be received by the user corresponding to the amount calculated as the won.

In step S311, the control unit 250 determines whether there is change during the process of exchanging the inserted medium. For example, when the inserted 10 dollars are exchanged, the amount is approximately 10,500 won in accordance with the exchange rate, so that coin as a change (approximately, 500 won) is generated.

In step S312, when the change is generated, the control unit 250 outputs a message of requesting a membership card in the case of the member of the membership and a message of requesting to input a password in the case of a non-member of the membership, through the display device 220.

In step S313, when the user is not a member of the membership, a password is input through the input unit 210.

In step S314, the control unit 260 reports information on the input password and the change to the CMS 400 through the communication unit 240 and outputs the ticket for the change and/or the receipt for the change through a print unit (not illustrated). The ticket for the change may include an amount of the change and a serial number.

In step S315, when the user is a member of the membership, the membership number is input through the input unit 210.

In step S316, the control unit 250 requests the CMS 400 to accumulate the change in the input membership number through the communication unit 240.

In step S317, the control unit 250 ejects the exchanged won through the medium accepting/dispensing unit 230.

In step S318, the control unit 250 transmits an exchanging result to the CMS 400 through the communication unit 240. For example, the exchanging result may include an amount of received foreign currency, a type of exchanged Korean won; and number of money information. Therefore, the medium which is received by the second financial device 200 for exchanging currency may be managed through the CMS 400 in real time.

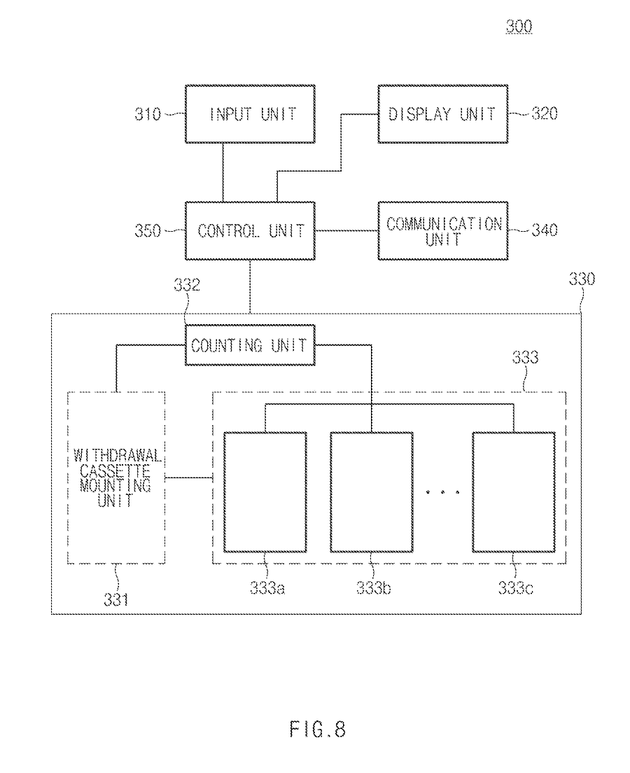

FIG. 8 is a block diagram illustrating a third financial device of a casino management system according to an exemplary embodiment of the present disclosure.

Referring to FIG. 8, the third financial device 300 of the casino management system according to an exemplary embodiment of the present disclosure may include an input unit 310, a display unit 320, an adjusting unit 330, a communication unit 340, and a control unit 350.

The input unit 310 receives an ID of a dealer who changes the cassettes of the first financial device 100 which is installed in the adjusting unit 330 for adjustment and/or the second financial devices 200a, 200b, . . . , 200c.

The display unit 320 outputs counting result information, and adjusting result information for the medium stored in the cassettes of the first financial device 100 which is installed in the adjusting unit 330 for adjustment and/or the second financial devices 200a, 200b, . . . , 200c. For example, the display unit 320 and the input unit 310 may be configured by one module, like a touch panel or a touch screen and the user checks the information output from the display unit 320 and inputs a command corresponding to the output information by touch.

The adjusting unit 330 may include a collected cassette mounting unit 331, a counting unit 332 and an adjustment cassette mounting unit 333.

The collected cassette mounting unit 331 may be mounted with cassettes (hereinafter, referred to as a ‘collected cassette’) which are collected from the first financial device 100 and/or the second financial devices 200a, 200b, . . . , 200c.

The counting unit 332 may count the medium which is transferred from the collected cassette to the adjustment cassette. The counting unit 332 transfers the counting result to the control unit 350.

The adjustment cassette mounting unit 333 may include at least one of the adjustment cassettes 333a, 333b, . . . , 333c to store the medium transferred from the collected cassette.

The communication unit 340 communicates with the CMS 400 through the local area network (LAN). The communication unit 340 transmits an adjusting result to the CMS 400. Further, the communication unit 340 receives a comparison result obtained by comparing cash data for the collected cassette stored in the CMS 400 with the adjusting result from the CMS 400. The cash data may refer to data in which chip exchanging result information or exchanging result information of cassettes mounted in the first financial device 100 and the second financial devices 200a, 200b, . . . , 200c are stacked by adjusting time.

The control unit 350 controls the adjusting unit 330 to adjust the medium stored in the collected cassette. When a dealer ID corresponding to the collected cassette mounted in the collected cassette mounting unit 331 is input, the control unit 350 determines whether a predetermined dealer ID of the mounted collected cassette matches an input dealer ID. When the dealer IDs do not match, the control unit 350 outputs a warning message through the display unit 320. When the dealer IDs match, the control unit 350 controls the adjusting unit 330 to transfer the medium stored in the collected cassette to the adjusting cassettes 333a, 333b, . . . , 333c. During the process of transferring the medium stored in the collected cassette to the adjustment cassette, when the adjustment cassette is full, the control unit 350 controls to transfer the medium which remains in the collected cassette to another adjustment cassette. Further, the control unit 350 receives a counting result of the medium stored in the collected cassette from the counting unit 332. The control unit 350 adjusts at least one of the collected cassettes corresponding to the dealer ID and transmits the adjusting result to the CMS 400 through the communication unit 340. The adjusting result may include an input dealer ID and a counting result.

In the meantime, when the cash data of the collected cassette mounted in the collected cassette mounting unit 331 does not match the adjusting result, in accordance with the comparison result received from the CMS 400, the control unit 350 controls the adjusting unit 330 to readjust the adjusted medium.

As described above, the third financial device 300 according to an exemplary embodiment of the present disclosure is mounted with the medium storing cassettes collected from the first financial device 100 and/or the second financial devices 200a, 200b, . . . , 200e to perform adjustment using the collected cassette so that a dealer, a cashier, and other casino employees are prevented from being in contact with the cash. Therefore, the casino management system according to the exemplary embodiment of the present disclosure may establish transparent cash management.

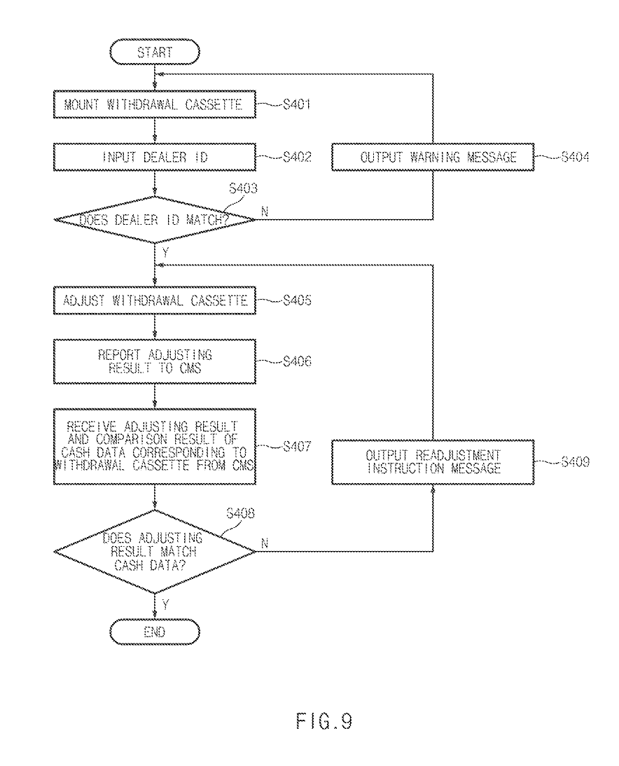

FIG. 9 is a flow chart illustrating a cash management method of a casino management system according to a first exemplary embodiment using the third financial device according to the exemplary embodiment of the present disclosure.

Referring to FIG. 9, the cash management method of the casino management system according to a first exemplary embodiment includes a step S401 of mounting a collected cassette in a collected cassette mounting unit, a step S402 of inputting a dealer ID, a step S403 of determining whether a dealer ID which is set in advance in the mounted collected cassette matches an input dealer ID, a step S404 of outputting a warning message when the dealer ID which is set in advance in the mounted collected cassette does not match the input dealer ID, a step S405 of adjusting the medium stored in the collected cassette when the dealer ID which is set in advance in the mounted collected cassette matches the input dealer ID, a step S406 of reporting the adjusting result to the CMS, a step S407 of receiving a comparison result of the adjusting result and the cash data corresponding to the collected cassette from the CMS, a step S408 of determining whether the adjusting result does match the cash data, and a step S409 of outputting a readjustment instruction message when the adjusting result does not match the cash data.

Hereinafter, steps S401 to S409 will be described in more detail with reference to FIG. 8.

In step S401, cassettes which are collected from the first financial device 100 and/or the second financial devices 200a, 200b, . . . , 200c are mounted in the collected cassette mounting unit 331 of the third financial device 300.

In step S402, the input unit 310 receives an ID of a dealer who is in charge of the collected cassette mounted in the collected cassette mounting unit 331.

In step S403, the control unit 350 determines whether the dealer ID input through the input unit 310 matches the dealer ID which is set in advance in the collected cassette.

In step S404, the control unit 350 outputs a warning message through the display unit 320 when the dealer ID input through the input unit 310 does not match the dealer ID which is set in advance in the collected cassette.

In step S405, the control unit 350 adjusts the collected cassette when the dealer ID input through the input unit 310 matches the dealer ID which is set in advance in the collected cassette. Specifically, the control unit 350 transfers the medium stored in the collected cassette to at least one of the adjusting cassettes 333a, 333b, . . . , 333c through the counting unit 332.

In step S406, when the medium is completely transferred from the collected cassette to at least one of the adjusting cassettes 333a, 333b, . . . , 333c, the control unit receives a counting result for the medium from the counting unit 332. Further, the control unit 350 transmits an adjusting result to the CMS 400 through the communication unit 340.

In step S407, the control unit 350 receives a comparison result obtained by comparing cash data for the collected cassette stored in the CMS 400 with the adjusting result from the CMS 400.

In step S408, the control unit 350 determines whether the cash data for the collected cassette matches the adjusting result for the collected cassette, based on the comparison result.

In step S409, when the cash data for the collected cassette does not match the adjusting result for the collected cassette, the control unit 350 outputs a readjusting instruction message to the display unit 320.

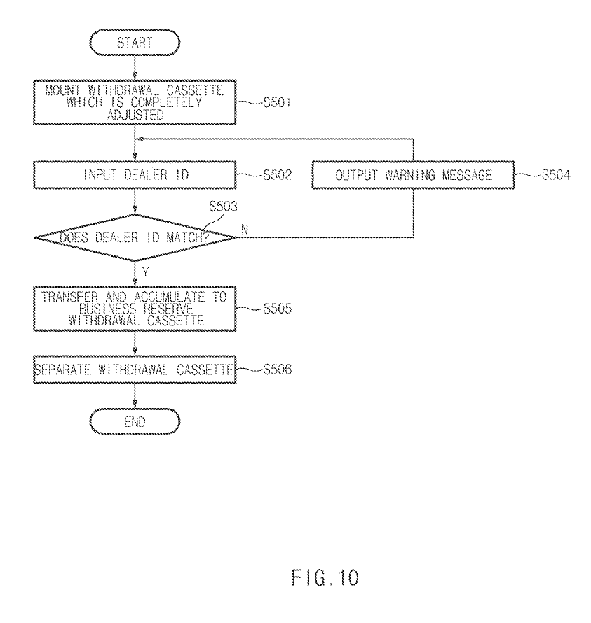

FIG. 10 is a flow chart illustrating a cash management method of a casino management system according to a second exemplary embodiment using the third financial device according to the exemplary embodiment of the present disclosure.

Specifically, the cash managing method of the casino management system illustrated in FIG. 10 may be understood as a process of processing a business reserve of the second financial devices 200a, 200b, . . . , 200c after completely making adjustments. This is because the second financial devices 200a, 200b, . . . , 200c need a predetermined business reserve for a medium exchanging process.

Referring to FIG. 10, the cash managing method of the casino management system according to a second exemplary embodiment includes a step S501 of mounting a collected cassette in which the adjustment is completed in a collected cassette mounting unit, a step S502 of inputting a dealer ID, a step S503 of determining whether the dealer ID which is set in advance in the mounted collected cassette matches the input dealer ID, a step S504 of outputting a warning message when the dealer ID which is set in advance in the mounted collected cassette does not match the input dealer ID, a step S505 of storing a predetermined business reserve which is set in advance in the collected cassette, and a step S506 of dividing the collected cassettes.

Hereinafter, steps S501 to S506 will be described in more detail with reference to FIG. 8.

First, in step S501, a collected cassette in which the adjusting process is completed is mounted in the collected cassette mounting unit 331. For example, the collected cassette in which the adjusting process is completed may be a cassette mounted in the second financial devices 200a, 200b, . . . , 200c.

In step S502, the input unit 310 receives an ID of a dealer who is in charge of the collected cassette mounted in the collected cassette mounting unit 331.

In step S503, the control unit 350 determines whether the dealer ID input through the input unit 310 matches the dealer ID which is set in advance in the collected cassette.

In step S504, the control unit 350 outputs a warning message through the display unit 320 when the dealer ID input through the input unit 310 does not match the dealer ID which is set in advance in the collected cassette.

In step S505, the control unit 350 controls the adjusting unit 330 to transfer the medium stored in the adjusting cassettes 333a, 333b, . . . , 333c by a predetermined amount (that is, business reserve) to the collected cassette.

In step S506, the collected cassette which withdraws the business reserve is separated from the collected cassette mounting unit 331.

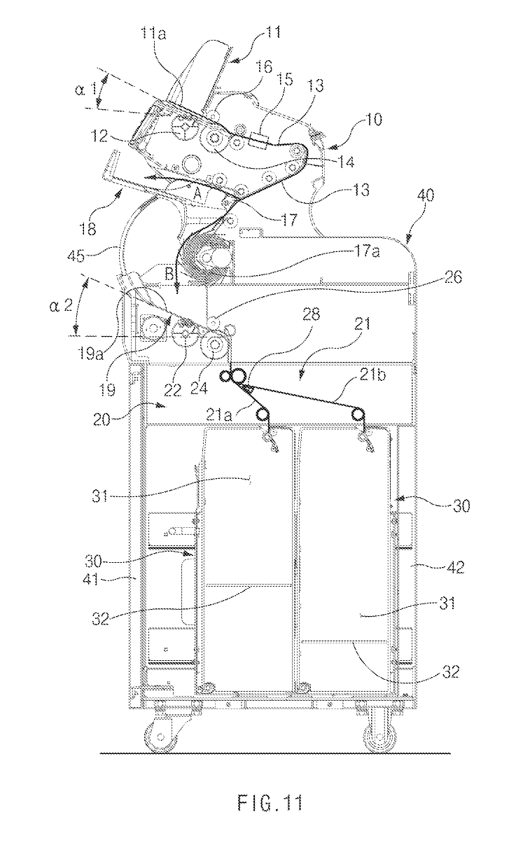

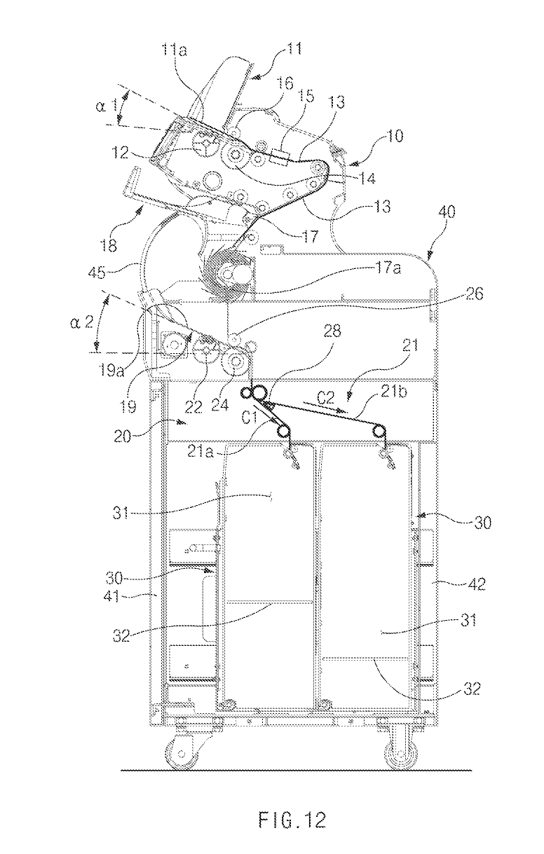

FIGS. 11 and 12 are views illustrating a recognizing and counting apparatus having a medium storing function according to a second embodiment of the present disclosure.

Referring to FIG. 11, a recognizing and counting apparatus having a medium storing function according to the exemplary embodiment of the present disclosure includes a counting unit 10 which counts a medium transferred from a hopper 11 and recognizes an abnormal medium, a reject pocket 18 in which abnormal medium recognized by the counting unit 10 to be abnormal is stacked, a normal medium pocket 19 in which a normal medium recognized by the counting unit 10 to be normal is stacked, one or more storage cassette 30 which is disposed below the normal medium pocket 19 to store the normal medium stacked in the normal medium pocket 19, and a conveying unit 20 which is placed between the counting unit 10 and the storing cassette to convey the normal medium.

In the meantime, the counting unit 10, the reject pocket 18, the normal medium pocket 19, the storage cassette 30, and the conveying unit 20 are provided in a case 40.

The counting unit 10 includes a hopper 11 which is provided at an uppermost side of the case 40, a counting transfer path 13 which is configured to transfer the medium in a predetermined direction from the hopper 11, a recognizing unit 15 which is provided in the middle of the counting transfer path 13 to recognize the abnormal medium, and a number counting unit (not illustrated) which counts the number of normal medium.

The hopper 11 has a hopper plate 11a which is inclined at a predetermined inclination angle α1. For example, the hopper 11 is disposed to be inclined at a predetermined inclination angle α1 with respect to the horizontal line so that medium stacked in the hopper plate 11a are normally separated into a sheet of the medium without having a pusher to be transferred to the counting transfer path. In this case, the inclination angle α1 of the hopper plate 11a may be an angle within 45 degrees with respect to the horizontal line so that the medium is separated into individual pages by a load of the medium.

The hopper 11 has at least one pair of side guides and a distance between the pair of side guides may be adjusted.

A counting pickup unit 12, 14, and 16 which picks up and takes out the medium stacked in the hopper plate 11a in the unit of a sheet of the medium are provided to be adjacent to the hopper 11 and the counting pickup unit 12, 14, and 16 performs a function of a first separating unit which separates the medium stacked in the hopper 11 into a sheet of the medium and takes out the medium.

Specifically, the counting pickup unit 12, 14, and 16 has a counting pickup roller 12 which is disposed to be adjacent to the hopper plate 11a of the hopper 11, a counting feed roller 14 which is provided at a downstream side of the counting pickup roller 12, and a counting separating roller 16 which is provided so as to be opposite to the counting feed roller 14.

The counting pickup roller 12 is configured to pick up the medium stacked in the hopper plate 11a of the hopper 11 in the unit of a sheet of the medium. A material having a large friction factor such as rubber is attached on an outer circumferential surface of the counting pickup roller 12 to easily pick up the medium.

The counting feed roller 14 is disposed at a downstream side of the counting pickup roller 12 to be adjacent thereto to transfer the medium which is picked up by the counting pickup roller 12. A material having a large friction factor such as rubber is attached on an outer circumferential surface of the counting feed roller 14 to smoothly transfer the medium.

The counting separating roller 16 is provided at an opposite side of the counting feed roller 14 to be spaced apart from the counting feed roller 14 and the counting separating roller 16 and the counting feed roller 14 are in cooperation with each other to transfer the medium in the unit of a sheet of the medium. The medium picked up by the counting pickup roller 14 passes and is transferred between the counting feed roller 14 and the counting separating roller 16. In this case, the counting separating roller 16 rotates in a reverse direction of a rotational direction of the counting feed roller 14 or stops, so that only one sheet of medium may pass and be transferred between the counting feed roller 14 and the counting separating roller 16.

Specifically, the counting pickup roller 12, the counting feed roller 14, and the counting separating roller 16 of the counting pickup unit 12, 14, 16 are disposed to correspond to the inclination angle α1 of the hopper plate 11a so as to easily pick up or transfer the medium.

As described above, according to the exemplary embodiment of the present disclosure, the hopper plate 11a of the hopper 11 is disposed to be inclined with respect to the horizontal line at an acute angle α1 and the counting pickup unit 12, 14, and 16 is disposed to be adjacent thereto, so that a transfer job for counting and recognizing the medium may be more stably and promptly performed.

A medium recognizing sensor (not illustrated) which detects whether the medium is stacked on the hopper plate 11a may be provided to be adjacent to the hopper plate 11a of the hopper 11. When the medium is recognized by the medium recognizing sensor, the counting pickup unit 12, 14, and 16 (first separating unit) is configured to operate after a predetermined time.

The counting transfer path 13 extends from the hopper 11 and the pickup unit 12, 14 and 16 and formed of a guide plate or at least one guide roller and/or belt, so that the medium may be stably transferred.

The recognizing unit 15 is configured to be provided in the middle of the counting transfer path 13 to recognize the abnormal medium while counting the number of transferred medium.

In the meantime, the recognizing unit 15 is configured by one or more recognizing sensor which recognizes the abnormal medium while counting the medium and the recognizing sensor may be configured by one or two or more of combined various sensors such as an image sensor, an ultraviolet sensor, an infrared sensor, a magnetic sensor, a color recognizing sensor, and a thickness recognizing sensor.

A path diverting unit 17 which selectively diverts the path through which the abnormal medium and the normal medium recognized by the recognizing unit 15 are transferred is disposed at a downstream side of the recognizing unit 15 and a reject pocket 18 is connected to one path which is adjacent to the path diverting unit 17, and a normal medium pocket 19 is connected to the other path which is adjacent to the path diverting unit 17.

As described above, according to the exemplary embodiment of the present disclosure, the abnormal medium which is recognized to be abnormal and the normal medium which is recognized to be normal by the recognizing unit 15 are divided by the path diverting unit 17 to be stacked into the reject pocket 18 and the normal medium pocket 19 so that the abnormal medium and the normal medium are very efficiently separated.

In this case, the recognizing unit 15 is disposed to be close to the counting pickup unit (first separating unit) and spaced apart from the path diverting unit 17 with at least a predetermined interval in order to normally switch the path of the abnormal medium and the normal medium recognized by the recognizing unit 15 by the path diverting unit 17.

A stack wheel 17a is interposed between the path diverting unit 17 and the normal medium pocket 19 so that the normal medium may be very easily stacked into the normal medium pocket 19.

The present disclosure is not limited to the above-described configuration but various design modifications may be allowed if the medium is counted and it is checked whether the medium is counterfeit and the medium is recognized.

According to an exemplary embodiment, the counting unit 10, the reject pocket 18, and the normal medium pocket 19 are provided in an upper portion of the case 40 and specifically, the hopper 11 of the counting unit 10 is disposed at the top of the case 40, so that the user may easily insert the medium, count the medium, check whether the medium is counterfeit, and check the type of medium.

A display unit (not illustrated) which displays the number of normal medium and the number of abnormal medium is provided on the entire upper surface of the case 40.

The reject pocket 18 is provided at a front upper side of the case 40 and the abnormal medium which is recognized to be abnormal by the recognizing unit 15 is stacked into the reject pocket 18 by a path diverting operation of the path diverting unit 17. Further, one side of the reject pocket 18 is disposed to be outwardly open at a front side of the case 40 and thus a consumer may easily collect the abnormal medium. Further, since the reject pocket 18 is located to be higher than the normal medium pocket 19, so that the abnormal medium may be easily collected.

The apparatus may further include a cover member which prevents the medium which is rejected to an opening of the reject pocket 18 from being discharged to the outside of the case 40. Since the medium which is stacked into the reject pocket 18 may be recognized as a normal medium when the consumer recognizes the medium again due to erroneous recognition of the recognizing unit 15, a collection frequency is high. Therefore, since the medium which is stacked in the reject pocket 18 needs to be easily collected, the cover member may be provided to be elastically supported at a periphery of the front opening of the reject pocket to block only a part of the opening.

The normal medium pocket 19 is provided to be disposed below the reject pocket 18 at a front upper side of the case 40 and the normal medium which is recognized to be normal by the recognizing unit 15 is stacked into the normal medium pocket 19 by a path diverting operation of the path diverting unit 17. One side of the normal medium pocket 19 is disposed to be outwardly open at the front upper side of the case 40 and a shutter 45 which blocks access to the normal medium is provided at the open side of the normal medium pocket 19 selectively to be open or closed. The shutter 45 rotates at one side of the case 40 and slides in a circular arc direction to open/close the open side of the normal medium pocket 19. As described above, the shutter 45 is provided to open/close the open side of the case 40 so as to strictly restrict the access to the normal medium which is stacked into the normal medium pocket 19. Specifically, the shutter 45 is configured such that a closed state is locked or released by a separate locking device (not illustrated). Therefore, when the open side of the normal medium pocket 19 is closed by the closing operation of the shutter 45, the user may not arbitrarily collect the medium, so that the normal medium is efficiently stored and the cash is effectively managed. In this case, even though the shutter is provided at the open side of the normal medium pocket, the shutter may be set so as not to operate while the counting operation is performed and the locking device may not operate even when the shutter operates.

The normal medium pocket 19 has an accumulating plate 19a which is inclined at a predetermined inclination angle α2. For example, the hopper 11 is disposed to be inclined at a predetermined inclination angle α2 with respect to the horizontal line so that medium stacked in the accumulating plate 19a are normally separated into a sheet of the medium without having a separate pusher to be transferred to the counting transfer path. In this case, the inclination angle α1 of the accumulating plate 19a may be an angle which is smaller than 45 degrees with respect to the horizontal line so that the medium is separated into individual pages by a load of the medium.

According to an exemplary embodiment, the inclination angle α2 of the accumulating plate 19a of the normal medium pocket 19 and the inclination angle α1 of the hopper plate 11a of the hopper 11 may have the substantially same angle.

An accepting pickup unit 22, 24, and 26 which picks up and takes out the normal medium stacked in the integrate plate 19a in the unit of a sheet of the medium is provided to be adjacent to the normal medium pocket 19 and the accepting pickup units 22, 24, and 26 performs a function of a second separating unit which separates the normal medium stacked in the normal medium pocket 19 into a sheet of the medium and takes out the medium.

Specifically, the accepting pickup unit 22, 24, and 26 has an accepting pickup roller 22 which is disposed to be adjacent to the accumulating plate 19a of the normal medium pocket 19, an accommodating feed roller 24 which is provided at a downstream side of the accepting pickup roller 22, and the accommodating separating roller 26 which is provided so as to be opposite to the accommodating feed roller 24.

The accepting pickup roller 22 is configured to pick up the medium stacked in the accumulating plate 19a of the normal medium pocket 19 in the unit of a sheet of the medium. A material having a large friction factor such as rubber is attached on an outer circumferential surface of the accepting pickup roller 22 to easily pick up the medium.

The accommodating feed roller 24 is disposed at a downstream side of the accepting pickup roller 22 to be adjacent thereto to transfer the medium which is picked up by the accepting pickup miler 22. A material having a large friction factor such as rubber is attached on an outer circumferential surface of the accommodating feed roller 24 to smoothly transfer the medium.

The accommodating separating roller 26 is provided at an opposite side of the accommodating feed roller 24 to be spaced apart from each other and the accommodating separating roller 26 and the accommodating feed roller 24 are in cooperation with each other to transfer the medium in the unit of a sheet of the medium. The medium picked up by the accepting pickup roller 24 pass and are transferred between the accommodating feed roller 24 and the accommodating separating roller 26. In this case, the accommodating separating roller 26 rotates in a reverse direction of a rotational direction of the accommodating feed roller 24 or stops, so that only one sheet of medium may pass and be transferred between the accommodating feed roller 24 and the accommodating separating roller 26.

Specifically, the accepting pickup roller 22, the accommodating feed roller 24, and the accommodating separating roller 66 of the accepting pickup unit 22, 24, and 26 forms a taking-out path so as to maintain a integration angle of the accumulating plate 19a.

As described above, according to the exemplary embodiment of the present disclosure, the accumulating plate 19a of the normal medium pocket 19 is disposed to be inclined with respect to the horizontal line at an acute angle α1 and the accepting pickup unit 22, 24, and 26 is disposed to be adjacent thereto, so that a conveying operation for accommodating the medium is more stably and promptly performed.

The storage cassette 30 is located below the normal medium pocket 19 and the normal medium which is stacked in the normal medium pocket 19 is automatically accommodated by the conveying unit 20 which will be described below, so that the normal medium is stably and promptly stored.

The storage cassette 30 includes a storage space 31 where the normal medium is stored and a support plate 32 which is movably provided to support the normal medium in the storage space 31, which is similar to the cassette of the general financial device.

The normal medium stacked in the accumulating plate 19a of the normal medium pocket 19 are supported by a support plate (not illustrated) of the storage cassette 30 via the conveying unit 20 so as to be stably stored in the storage space 31. In this case, an auxiliary recognizing unit (not illustrated) is further provided to sense that a medium passes between the conveying unit 20 and the storage cassette 30 and the auxiliary recognizing unit (not illustrated) is driven to be connected with the above-described recognizing unit 15. Therefore, when the number of medium which is recognized by the recognizing unit and the number of medium which is inserted into the storage cassette 30 by the auxiliary recognizing unit are different from each other, a warning may be given to the user and the warning is configured such that a message is displayed on a display or a sound or a message is transmitted to the outside of the device wirely and/or wirelessly.

According to a configuration, the storage cassette 30 is provided in a lower space of the case 40 to be separated and at least one side wall of the case 40 which is adjacent to the storage cassette 30, for example, a front wall of the lower side may be provided to be open/closed. As described above, since any one of the side walls of the case 40 is provided to be open/closed, when the medium are jammed while being accommodated in the storage cassette 30 or the storage cassette 30 is broken, the storage cassette 30 may be easily repaired. Further, the recognizing unit 15 at an upper side and the storage cassette 30 at a lower side are detachably coupled and the recognizing unit 15 at an upper side and the storage cassette 30 at a lower side are coupled to be open/closed, so that an accommodating conveyance path and the storage cassette 30 may be easily repaired.

According to another configuration, the storage cassette 30 may be fixed to a lower space of the case 40 in the form of a safe box and a door (not illustrated) is provided on at least one side wall of the storage cassette 30 to be open/closed so as to withdraw the stored normal medium. Further, the door (not illustrated) may be configured such that the closed state is locked and released by a separate locking device (not illustrated). Further, when any one side wall of the case 40 is provided to be open/closed and when the medium is jammed while being accommodated in the storage cassette 30, the one side wall is open to access the conveying unit 20 which connects the normal medium pocket 19 and the storage cassette 30, so that a repairing operation is easily performed. In this case, the conveying unit 20 is configured to be withdrawn in the openable side wall direction.

According to an exemplary embodiment, a plurality of storage cassettes 30 may be provided in the lower space of the case 40. As described, since the plurality of storage cassettes 30 is provided, the normal medium may be stored by various methods. For example, the normal medium may be stored by dividing by various methods, such as countries, types, users, dates, so that the convenience of usage is significantly increased.

The conveying unit 20, as illustrated in FIGS. 11 to 12, includes an accepting path 21 which conveys the normal medium from the normal medium pocket 19 to accommodate the normal medium in the storage cassette 30.

According to a configuration, the accepting path 21 has a plurality of accepting paths 21a and 21b which transfers the normal medium from the normal medium pocket 19 to individually accommodate the normal medium in each storage cassette 30. Further, each accepting path 21a and 21b may further include an auxiliary recognizing unit (not illustrated) which sense that the medium passes.

In a position where the plurality of accepting paths 21a and 21b are divided, an accepting path diverting unit 28 is provided and the accepting paths 21a and 21b are appropriately switched by the accepting path diverting unit 28, so that the normal medium may be accommodated in a desired storage cassette 30. As described above, a job which selectively stores the normal medium in the plurality of storage cassettes 30 may be easily performed by the accepting path diverting unit 28 and the plurality of accepting paths 21a and 21b. In this case, when the normal medium is stacked (or stored) in the storage cassette 30, a storage cassette 30 which accommodates the medium, among the plurality of storage cassettes 30 is determined in accordance with the medium recognition result at the time of primary counting and particularly, the storage cassette 30 to accommodate the medium may be determined in accordance with the size of the medium, the country of money (KRW, JPY, RMB, or USD), and an amount.

In the meantime, when the normal medium stored in the storage cassette 30 is withdrawn, the door of the storage cassette 30 is open or the storage cassette 30 is separated from the lower part of the case 40 to directly withdraw the normal medium.

The medium recognizing and counting operation which is performed by the recognizing and counting apparatus having the medium storing function according to the present disclosure configured as described above is illustrated in FIG. 11, which will be described in detail below.

After accumulating a medium such as paper money or check in the hopper plate 11a of the hopper 11, the medium which is stacked in the hopper plate 11a of the hopper 11 is picked up in the unit of separate page by the counting pickup unit 12, 14, and 16 to be transferred along the counting transfer path 13. In this case, when the medium recognizing sensor provided in the hopper plate 11a detects that the medium is stacked, a counting operation of a medium which is stacked starts after a predetermined time without performing a counting start operation of the user.

As described above, when the medium is transferred through the counting transfer path 13, the recognizing unit 15 recognizes the abnormal medium such as a counterfeit paper money, a damaged paper money, or different type of medium and the abnormal medium is stacked by being transferred to the reject pocket 18 by the path diverting unit 17 (see a direction of an arrow A of FIG. 1) and the normal medium is transferred (see a direction of an arrow B of FIG. 1) to the normal medium pocket 19 by the path diverting unit 17.

In this case, since one side of the reject pocket 18 is open, the user may easily obtain the medium and one side of the normal medium pocket 19 is closed by a closing operation of the shutter 45, so that the user may not arbitrarily collect the medium.

When the medium recognizing and counting result is inconsistent with the content recognized by the client or the client wants to cancel the transaction, the reject pocket 18, the shutter 45, and the locking device of the shutter 45 are released, so that the user may easily take the medium from the open normal medium pocket 19.

As illustrated in FIG. 12, the normal medium which is normally counted is accommodated into the storage cassette 30 through the accepting path 21 of the conveying unit 20, after being checked by the client and specifically, the normal medium is transferred to the storage cassette 30 through the accepting paths 21a and 21b by the accepting path diverting unit 28 of the conveying unit 20 and accommodated in the storage cassette 30 (see directions of arrows C1 and C2 of FIG. 2). During such an accommodating process, a closed state of the shutter 45 is maintained so that the user cannot access to the counted normal medium and the medium is completely accommodated.

According to the present disclosure, after a first automatic counting operation which simultaneously checks whether the medium is counterfeit and checks the type of the medium during the medium counting process by the counting unit, a normal medium which is counted to be normal by the recognizing unit of the counting unit is stored in the storage cassette by a secondary automatic accommodating operation, so that it is possible to not only check forgery and the type of medium, but also store the normal medium which is counted to be normal and stably perform the cash management of the medium, so that the method may be utilized with high applicability, not only in the bank, but also a location where cash/check is frequently used, such as the casino or a retail shop.

The medium is accommodated in a state where the user cannot access to the counted medium, so that reliability is significantly improved.

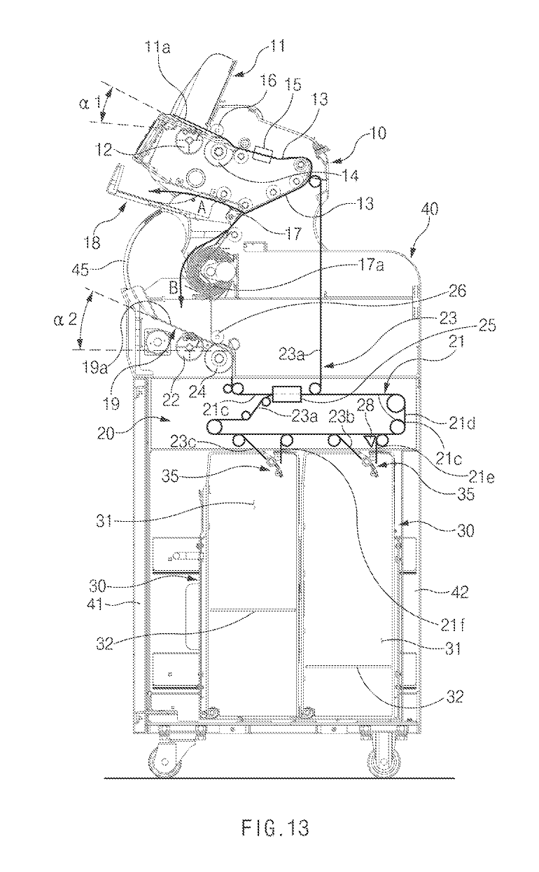

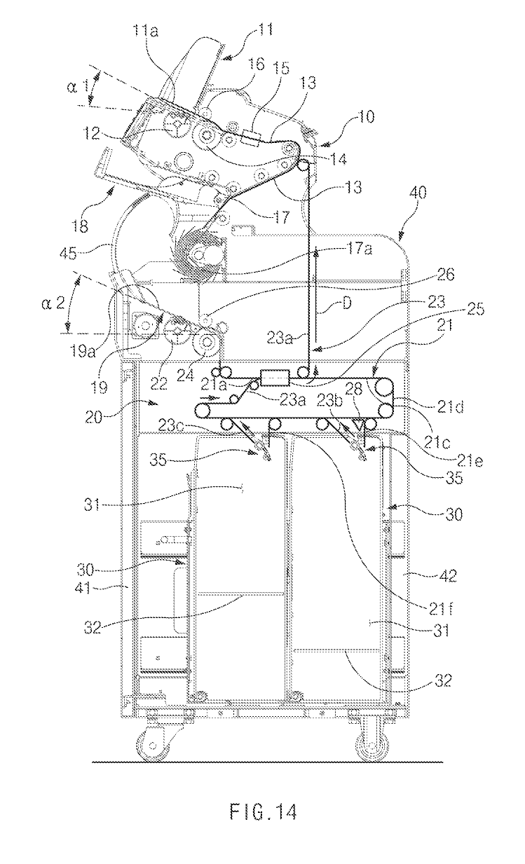

FIGS. 13 and 14 are views illustrating a recognizing and counting apparatus having a medium storing function according to another exemplary embodiment of the present disclosure.

Referring to FIGS. 13 and 14, a conveying unit 20 according to a second exemplary embodiment of the present disclosure includes an accepting path 21 which conveys the normal medium from the normal medium pocket 19 to the storage cassette 30 to accommodate the normal medium and a dispensing path 23 which conveys the normal medium to be withdrawn from the storage cassette 30 to the normal medium pocket 19.

As described above, according to the second exemplary embodiment of the present disclosure, the dispensing path 23 which partially intersects the accepting path 21 is separately configured, so that the normal medium may be simply withdrawn.

The storage cassette 30 according to the second exemplary embodiment of the present disclosure includes a storage space 31 in which the normal medium is stored, a support plate 32 which supports the normal medium in the storage space 31 or movably provided to apply a pressure to the normal medium at the time of withdrawing the medium, and a dispensing pickup unit 35 which withdraws the normal medium stored in the storage space 31.

The dispensing pickup unit 35 may be configured by a pickup roller, a separating roller, and a feed roller.

The accepting path 21 has a horizontal accepting path 21c which extends from the normal medium pocket 19 in a horizontal direction, a circular arc accepting path 21d which is provided at one edge of the horizontal accommodating unit 21c, and a plurality of divided accepting paths 21e and 21f which are individually divided from the circular arc accepting path 21d in accordance with the plurality of storage cassettes 30.

In a position where the plurality of divided accepting paths 21e and 21f is divided, the accepting path diverting unit 28 is provided and the divided accepting paths 21e and 21f are appropriately switched by the accepting path diverting unit 28, so that the normal medium may be accommodated in a desired storage cassette 30.

The dispensing path 23 has a combined dispensing path 23a which partially intersects the horizontal accepting path 21e of the accepting path 21 and a plurality of individual dispensing paths 23b and 23c which individually extends from the storage cassettes 30 to meet the combined dispensing path 23a.

The combined dispensing path 23a is formed such that the combined dispensing path 23a partially intersects the horizontal accepting path 21c of the accepting path 21 and individual dispensing paths 23b and 23c meet at one end of the combined dispensing path 23a and the other end of the combined dispensing path 23a meets one side of the counting transfer path 13 of the counting unit 10.

Specifically, the dispensing path 23 is disposed to detour the accepting pickup unit 22, 24, and 26 so that the withdrawn medium does not pass the accepting pickup unit 22, 24, and 26. Therefore, conveyance of the medium in the accommodating direction by the accepting pickup unit 22, 24, and 26 and conveyance of the medium in the dispensing direction by the dispensing pickup unit 35 of the storage cassette 30 do not interfere with each other, so that the normal medium may be stably stored and withdrawn.

According to the present disclosure, the accepting path 21 and the dispensing path 23 are configured to intersect each other, so that a distance between the normal medium pocket 19 and the storage cassette 30 is significantly reduced and thus the entire size may be implemented to be compact, thereby reducing the size thereof.

In the meantime, an auxiliary recognizing unit 25 which recognizes the medium may be provided in a path which is connected to the storage cassette 30. For example, the auxiliary recognizing unit 25 may be provided in a portion where the accepting path 21 and the dispensing path 23 intersect or only in the dispensing path 23.

The auxiliary recognizing unit 25 is configured by a recognizing sensor only enough to recognize the number of the normal medium, a letter included in the medium, and the type of medium when the medium are accommodated and/or withdrawn so that the structure may be very simple as compared with the recognizing unit 15 of the counting unit 10.

The type or the number of normal medium which are accommodated or withdrawn may be exactly detected by the auxiliary recognizing unit 25.

The medium dispensing operation which is performed by the recognizing and counting apparatus having the medium storing function according to the second exemplary embodiment of the present disclosure configured as described above is illustrated in FIG. 14, which will be described in detail below.

The normal medium stored in the storage cassette 30 is transferred to the counting transfer path 13 of the counting unit 10 after passing the auxiliary recognizing unit 25 through the dispensing path 23 of the conveying unit 20 and then transferred to the normal medium pocket 19 or the reject pocket 18 through the counting transfer path 13, so that the normal medium may be easily withdrawn.

Specifically, the normal medium which are stored in the plurality of storage cassettes 30 is picked up by the dispensing pickup unit 35 in the unit of separate page and then individually transferred through the individual dispensing paths 23b and 23c of the dispensing path 23 and transferred to the counting transfer path 13 through the combined dispensing path 23a to be stacked in the normal medium accumulating unit or the reject pocket (see a direction of an arrow D of FIG. 14).

According to an alternative exemplary embodiment, at least one of the plurality of storage cassettes 30 may be used as an exclusive dispensing cassette and a separate conveyance path is connected to the exclusive dispensing cassette, and the conveyance path of the exclusive dispensing cassette is configured not to intersect the accepting path.

Even though all components of the exemplary embodiment of the present disclosure may be combined as one component or operates to be combined, the present disclosure is not limited to the exemplary embodiment. In other words, one or more of all of the components may be selectively combined to be operated within a scope of the present disclosure. Further, all of the components may be implemented as one independent hardware but a part or all of the components are selectively combined to be implemented as a computer program which includes a program module which performs a part or all of functions combined in one or plural hardwares. Further, codes and code segments which configure the computer program may be easily deducted by those skilled in the art. The computer program is stored in a computer readable medium to be read and executed by a computer so as to implement an exemplary embodiment of the present disclosure. The storage medium of the computer program may include a magnetic recording medium, an optical recording medium, or a carrier wave medium.

The word “comprise”, “configure”, or “have” used in the above description will be understood to imply the inclusion of stated elements unless explicitly described to the contrary, so that the word will be interpreted to imply the inclusion of other stated elements but not the exclusion of any other elements. If they are not contrarily defined, all terms used herein including technological or scientific terms have the same meaning as those generally understood by a person with ordinary skill in the art. A generally used terminology which is defined in a dictionary may be interpreted to be equal to a contextual meaning of the related technology but is not interpreted to have an ideal or excessively formal meaning, if it is not apparently defined in the present disclosure.

It will be appreciated that various exemplary embodiments of the present disclosure have been described herein for purposes of illustration, and that various modifications, changes, and substitutions may be made by those skilled in the art without departing from the scope and spirit of the present disclosure. Accordingly, the exemplary embodiments disclosed herein are intended to not limit but describe the technical spirit of the present disclosure and the scope of the technical spirit of the present disclosure is not restricted by the exemplary embodiments. The protection scope of the present disclosure should be interpreted based on the following appended claims and it should be appreciated that all technical spirits included within a range equivalent thereto are included in the protection scope of the present disclosure.

What is claimed is:

1. A recognizing and counting apparatus, comprising:
a counting unit including a hopper in which an inserted medium is stacked; a first separating unit which separates the medium stacked in the hopper into a sheet of the medium and transfers the medium; a recognizing unit which recognizes the medium transferred from the hopper, a reject pocket in which an abnormal medium recognized to be abnormal by the recognizing unit is stacked; a normal medium pocket in which a normal medium normally counted by the recognizing unit is stacked; and a second separating unit which separates medium stacked in the normal medium pocket into a separate sheets to transfer the medium;
at least one storage cassette which is placed below the normal medium pocket to store the normal medium stacked in the normal medium pocket; and
a transferring unit which is provided between the counting unit, the normal medium pocket, and the storage cassette to transfer the normal medium which is separated into a sheet of the medium by the second separating unit.

2. The recognizing and counting apparatus of claim 1, wherein the hopper includes a medium recognizing sensor which recognizes a medium stacked in the hopper, and when the medium is recognized by the medium recognizing sensor, the first separating unit operates after a predetermined time.

3. The recognizing and counting apparatus of claim 1, wherein one side of the reject pocket is formed to outwardly open and a shutter is provided at one side of the normal medium pocket to be open or closed, and a closed state of the shutter is locked or released by a locking device.

4. The recognizing and counting apparatus of claim 3, wherein the closed state of the shutter is released by the locking device when the medium is counted by the recognizing unit and the closed state of the shutter is locked when the medium is transferred to the storage cassettes after counting the medium by the recognizing unit.

5. The recognizing and counting apparatus of claim 1, wherein the hopper has a hopper plate in which the medium is stacked and the normal medium pocket has an accumulating plate in which the normal medium is accumulate; the hopper plate of the hopper and the accumulating plate of the normal medium pocket are disposed to be inclined at the same inclination angle.

6. The recognizing and counting apparatus of claim 1, wherein the second separating unit includes an accepting pickup roller which is provided to be adjacent to the normal medium pocket, an accommodating feed roller which is provided at a downstream side of the accepting pickup roller, and an accommodating separating roller which is disposed to be opposite to the accommodating feed roller.

7. The recognizing and counting apparatus of claim 1, wherein a plurality of storage cassettes is provided, and the conveying unit has an accepting path which conveys the normal medium from the normal medium pocket to be accommodated in the plurality of storage cassettes and the accepting path has a plurality of divided accepting paths which is individually connected to the plurality of storage cassettes.

8. The recognizing and counting apparatus of claim 1, wherein an accepting path diverting unit is provided in a position where the plurality of divided accepting paths is divided.

9. The recognizing and counting apparatus of claim 1, wherein the storage cassette has a storage space where the normal medium is stored and a dispensing pickup unit which withdraws the medium in the storage space.

10. The recognizing and counting apparatus of claim 7, wherein the conveying unit further include a dispensing path which conveys the normal medium stored in the storage cassette to the normal medium pocket.

11. The recognizing and counting apparatus of claim 1, wherein an auxiliary recognizing unit which recognizes a withdrawn medium is provided in the middle of the dispensing path.

12. The recognizing and counting apparatus of claim 1, wherein the storage cassette is provided in a lower space of the case to be separated and at least one side wall of the case which is adjacent to the storage cassette is provided to be open/closed.

13. The recognizing and counting apparatus of claim 1, wherein the storage cassette is configured to have a safe box structure which is fixed to a lower space of the case.

14. A financial management system, comprising:
a server;
a first financial device which stores an inserted first medium, calculates information of the number of chips which is exchanged by the first medium, and transmits a chip exchanging result of the first medium to the server;
a second financial device which stores an inserted second medium, obtains exchange rate information of the second medium, exchanges the second medium using the exchange rate information to transmit the exchanging result to the server; and
a third financial device which collects the first medium or/and the second medium to perform adjustment process and transmits the adjustment result to the server.

15. A financial device, comprising:
an input unit which receives an ID of a dealer who is in charge of a first cassette or a second cassette;
an adjusting unit which collects a first medium stored in the first cassette and a second medium stored in the second cassette to at least one adjusting cassette;
a communication unit which communicates with the server;
a control unit which transmits an adjusting result for the first medium or the second medium collected by the adjusting unit to the server; and
a display unit which outputs the adjusting result.

16. A financial device, comprising:
a medium accepting/dispensing unit which counts, recognizes, and stores a medium inserted by a user;
a communication unit which communicates with a server; and
a control unit which calculates and outputs information on the number of chips which are exchangeable from the medium, transmits the chip exchanging result to the server, and when a change is generated during the chip exchanging process, transmits a result of accumulating the change corresponding to a membership number of a user based on whether the user is a member of the membership of the casino or a result of issuing a ticket for the change to the server.
